(19) United States
(12) Patent Application Publication
(10) Pub. No.: US 2019/0161672 A1
(43) Pub. Date: May 30, 2019

(54) Proppant Materials for Additive Delivery

(71) Applicant: Saint-Gobain Ceramics & Plastics, Inc., Worcester, MA (US)

(72) Inventors: Stephen Bottiglieri, Whitinsville, MA (US); Ian Victor Kidd, Worcester, MA (US); Wesley S. Towle, North Grosvenordale, CT (US); Jingyu Shi, Hudson, OH (US)

(73) Assignee: Saint-Gobain Ceramics & Plastics Inc., Worcester, MA (US)

(21) Appl. No.: 16/300,355

(22) PCT Filed: May 11, 2017
(86) PCT No.: PCT/US2017/032230

§ 371 Date: Nov. 9, 2018

Related U.S. Application Data
(60) Provisional application No. 62/335,723, filed on May 13, 2016.

(51) Int. Cl. C09K 8/80

(52) U.S. Cl. CPC C09K 8/805; C09K 2208/28; C09K 2208/06

(57) ABSTRACT

A proppant material can include a core and an extended-release coating overlying the core. The extended release coating can include a polymer and an additive contained within the polymer.

### CROSS-REFERENCE TO RELATED APPLICATION

This application claims the benefit of U.S. Provisional Application No. 62/335,723 filed May 13, 2016 and International Application PCT/US2017/032230 filed May 11, 2017.

### FIELD OF THE DISCLOSURE

The present disclosure relates to coatings for proppant materials and, more particularly, to coatings that contain an additive to be released from the coating.

### RELATED ART

Hydraulic fracturing can include injecting fracturing fluids into a wellbore under high pressure to create cracks in rock formations to release hydrocarbon materials such as oil and gas. Proppants can be inserted into the wellbore to hold the fractures open after the hydraulic pressure is reduced. Chemicals or other additives can be delivered along side the proppants for a variety of purposes, such for wellbore stimulation, treatment, or tracking. There exists a need for improved delivery of such additives.

### BRIEF DESCRIPTION OF THE DRAWINGS

Embodiments are illustrated by way of example and are not limited in the accompanying figures.

FIG. 1 includes an illustration of a proppant material according to an embodiment described herein.

FIG. 2 includes an illustration of a proppant material with an additive concentration gradient according to an embodiment described herein.

FIG. 3 includes an illustration of a proppant material with an additive concentration gradient according to another embodiment described herein.

FIG. 4 includes a graph plotting the results of the test described in the Example.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the proppant and chemical delivery arts. The concepts are better understood in view of the embodiments described below that illustrate and do not limit the scope of the present invention.

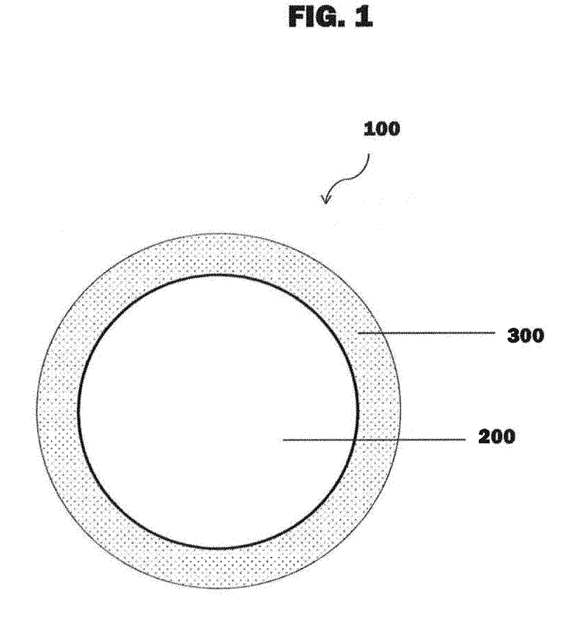

This disclosure is related to a coating comprising a polymer and an additive contained within the polymer. As illustrated in FIG. 1, a proppant 100 can include a core 200 and a coating 300 overlying the core 200. The coating can be an extended-release coating. As used herein, the term “extended-release coating” refers to a coating adapted to selectively release the additive over time, as opposed to immediately, upon interaction with a predetermined fluid medium. For example, a proppant including the coating can be deposited in a fluid medium to form a composition and selectively release the additive over time as the coating interacts with the fluid medium. Further, the composition can be disposed within a subterranean formation and the additive can be released to treat the subterranean formation over an extended time frame. Further, the composition can include at least one proppant including the coating and at least one proppant that does not include the coating.

In certain embodiments, the extended-release properties of the coating can be quantified using a release rate. The term “release rate” refers to the percentage of the total amount of additive released from the coating to a predetermined fluid medium in a given amount of time. The release rate of the extended-release coating can be measured according to the Additive Release Test described below.

The Additive Release Test includes providing 2.5 wt % of sample proppant (based on a total weight of sample proppant and test fluid medium) into a test fluid medium in a 1 L cylindrical PYREX® glass beaker having a diameter of 108 mm and a height of 158 mm, stored at a temperature of 21° C. For example, for 500 grams of test fluid medium, 12.5 g of sample proppant is provided to the test fluid medium in the vessel. The test fluid medium depends on the solubility of the additive. For water-soluble materials, a brine solution made according to ASTMD1141-98 is used. For non-water-soluble materials, a hydrocarbon-based solution is used, the term “hydrocarbon-based solution” referring to a solution having a hydrocarbon as the primary constituent of the specific solution. In addition, the test fluid medium is selected so that the solubility limit of the test fluid medium is sufficient to measure the full extend of the release rate. For example, if the sample proppant has a 1 hour release rate of at least 1 wt %, as discussed below, the test fluid medium must be such that the additive is at least 1 wt % soluble in the test fluid medium.

After the sample proppant is provided to the test fluid medium in the vessel, the proppant is permitted to settle and remain unstirred. A 10 mL sample of the proppant-filled solution is collected at intervals of at least 1 hr, 24 hrs, 72 hrs, and 168 hrs from about the center line of the test medium in the vessel at the designated time. The intervals are measured from the initial contact of the sample proppant with the test fluid medium. The 10 mL sample is measured for the additive of interest using a detection device capable of determining ppm levels of such additive. For example, inductively coupled plasma optical emission spectrometry can be used to measure phosphorous content when sampling the release of phosphoric acid.

The measured intervals are used to calculate the release rate. For example, the release rate can include a 1 hour release rate. As used herein, the term “1 hour release rate” refers to the total amount of additive released into the test fluid medium within the first hour after the sample proppant contacts the test fluid medium according to the Additive Release Test, measured in weight percent of additive released into the test fluid medium based on the initial total amount of additive in the coating.

The release rate can include a 24 hour release rate. As used herein, the term “24 hour release rate” refers the total amount of additive released into the test fluid medium within the first 24 hours after the sample proppant contacts the test fluid medium according to the Additive Release Test, measured in weight percent of additive released into the test fluid medium based on the initial total amount of additive in the coating.

The release rate can include a 168 hour release rate. As used herein, the term “168 hour release rate” refers to the total amount of additive released into the test fluid medium within the first 168 hours after the sample proppant contacts the test fluid medium according to the Additive Release Test, measured in weight percent of additive released into the test fluid medium based on the initial total amount of additive in the coating.

For example, in an embodiment, the coating can have a 1 hour release rate of at most 1 wt %, or at most 0.9 wt %, or at most 0.8 wt %, or at most 0.7 wt %, according to Additive Release Test. Further, the coating can have a 1 hour release rate of at least 0.001 wt %, or at least 0.005 wt %, or at least 0.01 wt %, according to the Additive Release Test. Furthermore, the coating can have a 1 hour release rate in a range of any of the above minimum or maximum values, such as 0.001 to 1 wt %, or 0.005 to 0.8 wt %, or 0.01 to 0.6 wt %, according to the Additive Release Test.

In a further embodiment, the coating can have a 24 hour release rate of at most 6 wt %, or at most 8 wt %, or at most 10 wt %, according to the Additive Release Test. Further, the coating can have a 24 hour release rate of at least 0.1 wt %, or at least 0.5 wt %, or at least 1 wt %, according to the Additive Release Test. Furthermore, the coating can have a 24 hour release rate in a range of any of the above minimum or maximum values, such as 0.1 to 10 wt %, or 0.5 to 8 wt %, or 1 to 6 wt %, according to the Additive Release Test.

In a further embodiment, the coating can have a 168 hour release rate of at most 16 wt %, or at most 18 wt %, or at most 20 wt %, as measured according to the Additive Release Test. Further, the coating can have a 168 hour release rate of at least 1 wt %, or at least 2 wt %, or at least 3 wt %, according to the Additive Release Test. Furthermore, the coating can have a 168 hour release rate in a range of any of the above minimum or maximum values, such as 1 to 20 wt %, or 2 to 18 wt %, or 3 to 16 wt %, as measured according to the Additive Release Test.

In an embodiment, the coating is a non-absorbent coating. As used herein with respect to the coating, the term “non-absorbent” refers to a coating having a three-dimensional network that does not bloat or expand to greater than 10 vol %, based on a total volume of the coating, when the coating comes in contact with the test fluid medium of the Additive Release Test. A solid coating is distinct from a gel coating because the three-dimensional network of a gel absorbs fluid and expands throughout its whole volume. For example, a hydrogel is a highly absorbent polymeric network that can expand to contain over 90 vol % water based on a total volume of the hydrogel.

The coating can include a polymer. In certain embodiments, the polymer can be present in the coating in an amount of at least 10 wt %, or at least 20 wt %, or at least 40 wt %, or at least 60 wt %, or at least 80 wt %, based on a total weight of the coating. In other embodiments, the polymer can be present in an amount of no greater than 99.99 wt %, no greater than 99.95 wt %, or no greater than 99.9 wt %, based on a total weight of the coating. Moreover, the polymer can be present in an amount within the above minimum and maximum values, such as 10 wt % to 99.9 wt %, 20 wt % to 99.9 wt %, or 40 wt % to 99.9 wt %, or 60 wt % to 99.95 wt %, or 80 wt % to 99.99 wt %, based on a total weight of the coating.

In certain embodiments, the polymer can include a degradable polymer. In further embodiments, the polymer can include an epoxy polymer, an acrylic polymer, a polyurethane, a formaldehyde, a silicone, a bio-based polymer, or any combination thereof. In particular embodiments, the epoxy polymer can include a bisphenol epoxy, a novolac epoxy, an aliphatic epoxy, a glycidyl amine epoxy, or any combination thereof. In particular embodiments, the acrylic polymer can include a methacrylate, methyl acrylate, a polymethyl acrylate, or any combination thereof. In particular embodiments, the polyurethane polymer can include a combination of an isocyanate and a polyol. For example, the isocyanate can include a toluene diisocyanate or a methylene diphenyl diisocyante, and the polyol can include a sucrose or a sorbitol. In particular embodiments, the formaldehyde can include a phenol formaldehyde, a melamine formaldehyde, a urea formaldehyde, a resorcinol formaldehyde, or any combination thereof. In particular embodiments, the silicone polymer can include any form of polymerized siloxane having an Si—O backbone. In particular embodiments, the bio-based polymer can include a sugar, such as a saccharose, a dextrose, or a molasses, a starch, or any combination thereof. As discussed above, the coating can include a non-absorbent coating. In an embodiment, the coating does not include a hydrogel or a hydrogel polymer.

The coating can include an additive contained within the polymer. The additive can be a material added to the coating to be released into a subterranean formation for stimulation, treatment, or tracking of the subterranean formation. In certain embodiments, the additive can be present in the coating in an amount of no greater than 90 wt %, or no greater than 80 wt %, no greater than 60 wt %, no greater than 40 wt %, or no greater than 20 wt %, based on a total weight of the coating. In other embodiments, the additive can be present in the coating in an amount of at least 0.01 wt %, or at least 0.05 wt %, or at least 0.1 wt/o, based on a total weight of the coating. Moreover, the additive can be present in the coating in a range of any of the above minimum or maximum values, such as 90 wt % to 0.1 wt %, or 80 wt % to 0.1 wt %, or 60 wt % to 0.1 wt %, or 40 wt % to 0.05 wt %, or 40 wt % to 0.05 wt %, or 20 wt % to 0.01 wt %, based on a total weight of the coating.

In certain embodiments, the additive can be present in the coated proppant in an amount of no greater than 50 wt %, or no greater than 45 wt %, or no greater than 40 wt %, based on the total weight of the coated proppant. In other embodiments, the additive can be present in the coated proppant in an amount of at least 0.01 wt %, or at least 0.05 wt %, or at least 0.1 wt %, based on the total weight of the coated proppant. Moreover, the additive can be present in the coated proppant in a range of any of the above minimum or maximum values, such as 0.01 wt % to 50 wt %, or 0.05 wt % to 45 wt %, or 0.1 wt % to 40 wt %/o, based on the total weight of the coated proppant.

In certain embodiments, the additive can be a chemical additive. In particular embodiments, the chemical additive can include a paraffin inhibitor, a scale inhibitor, a friction reducer, a tracer, an asphaltene inhibitor, a biocide, an oxygen inhibitor, an iron sulfide inhibitor, an iron inhibitor, a hydrogen sulfide inhibitor, or any combination thereof. In particular embodiments, the additive can include an imidazolines, an ethylene vinyl acetate, an olefin, an acrylate, a phosphonic acid, phosphoric acid, a fumaric acid, a polymaleic acid, a polymethacrylic acid, a polyacrylic acid, a polyepoxysuccinic acid, a carboxylates, a graphite, a caprylic alcohol, an acrylamide, an ammonium sulfate, a polytetrafluoroethylene, an inorganic salt, a magnetic particle, a dye, a fluorescent compound, a biological marker, a nonyl-phenol formaldehyde alkylphenol/aldehyde resin, a polyolefin ester, a lignosulfonate, an organic nitrate, an inorganic nitrate, a 2,2-dibromo-3-nitrilopropionamide (also known as DBNPA), an acetaldehyde, an ammonium bisulfite, a benzylideneacetaldehyde, a potassium acetate, a formamide, or any combination thereof.

In particular embodiments, the paraffin inhibitor can include an imidazoline, an ethylene vinyl acetate, an olefin, an acrylate polymers, or any combination thereof.

In particular embodiments, the scale inhibitor can include an imidazoline, a phosphonic acid, a phosphoric acid, a fumaric polymaleic acid, a polymethacrylic acid, a polyacrylic acid, a polyepoxysuccinic acid, a carboxylate, or any combination thereof.

In particular embodiments, the friction reducer can include an imidazoline, a graphite, a caprylic alcohol, an acrylamide, an ammonium sulfate, a polytetrafluoroethylene, or any combination thereof.

In particular embodiments, the tracer can include an inorganic salt, a magnetic particle, a dye, a fluorescent compound, a biological marker, or any combination thereof.

In particular embodiments, the asphaltene inhibitor can include a nonyl-phenol formaldehyde alkylphenol/aldehyde resin, a polyolefin ester, a lignosulfonate, or any combination thereof.

In particular embodiments, the biocide can include an organic nitrate, an inorganic nitrate, a DBNPA, or any combination thereof.

In particular, inhibitors and scavengers of oxygen, iron sulfide, iron, and hydrogen sulfide can include an imidazoline, an acetaldehyde, an ammonium bisulfite, a benzylideneacetaldehyde, a potassium acetate, a formamide, or any combination thereof.

The coating can include a control mechanism. The control mechanism can increase or decrease the release rate according to the Additive Release Test, or prevent or reduce release of the additive prior to interaction with the test fluid medium, or both.

The control mechanism can include a porosity within the coating. In an embodiment, the coating can have a porosity of at least 0.1 vol %, or at least 0.5 vol/%, or at least 1 vol %, or at least 5 vol %, based on a total volume of the coating. In an embodiment, the coating can have a porosity of at most 60 vol %, or at most 55 vol %, or at most 50 vol %, based on a total volume of the coating. Further, the coating can have a porosity in a range of any of the above minimum and maximum values, such as in a range of 0.1 vol % to 60 vol %, or 0.5 to 60 vol %, or 1 to 55 vol %, or 50 to 5 vol %.

In an embodiment, the porosity can include a plurality of pores having an average pore size of at least 0.1 microns, or a pore size of at least 0.5 microns, or a pore size of at least 1 micron. In an embodiment, the average pore size can be at most 35 microns, or at most 30 microns, or at most 25 microns. Further, the average pore size can be in a range of any of the above minimum and maximum values, such as in a range of 0.1 to 35 microns, or 1 to 30 microns, or 0.5 to 25 microns.

In an embodiment, the porosity can be formed into the coating through the addition of a surfactant. The surfactant can be mixed into the polymer and chemical mixture prior to coating and curing. Such surfactants can include polyoxyethylene glycol alkyl ethers, polyoxypropylene glycol alkyl ethers, polyoxyethylene glycol octylphenol ethers, glycerol ethers, glucoside alkyl ethers, or any combination thereof.

The control mechanism can include a stabilizer present within the coating. In an embodiment, the stabilizer includes an ultraviolet (UV) stabilizer, a thermal stabilizer, or both. The stabilizer can be present in an amount of at least 0.001 wt %, or at least 0.005 wt %, or at least 0.01 wt %, based on a total weight of the coating. Further, the stabilizer can be present in an amount of at most 4 wt %, or at most 3 wt %, or at most 2 wt %, based on a total weight of the coating. Moreover, the stabilizer can be present in the coating in range of any of the above minimum and maximum values, such as 0.001 to 4 wt %, or 0.005 to 3 wt %, or 0.01 to 2 wt %.

In an embodiment, the stabilizer can preferentially absorb or block free radical formation and propagation to reduce or eliminate breakage of carbon-carbon bonds in the polymer backbone, or removal of functional side groups. In an embodiment, the stabilizer can be mixed into the polymer prior to coating and curing. The stabilizer can include at least one of a hinder amine stabilizer (HAS), a benzophenone, a berrzotriazole, a benzoate, a salicylate, a acrylonitrile, a dilauryl thiodipropionate, a phenolic antioxidant, a pigment, or any combination thereof.

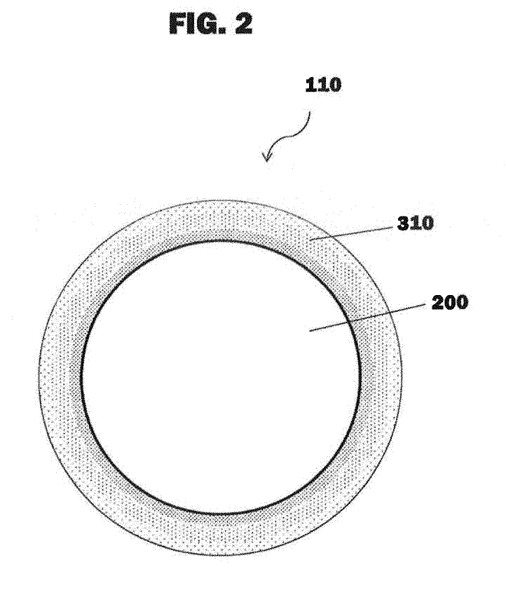

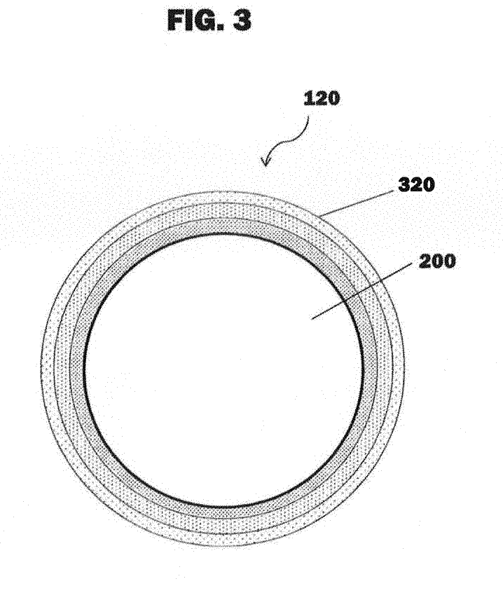

The coating can be prepared by dispersing the additive within the matrix of the polymer and, in certain embodiments, the additive can be dispersed randomly or uniformly within the polymer. In other embodiments, as illustrated in FIGS. 2 and 3, the control mechanism can include the additive being dispersed in the coating in a gradated manner. In a particular embodiment, the additive concentration gradient can include an additive concentration that increases from an exterior surface to a coating interface with the core. That is, the concentration is greater near the core than near the exterior surface of the coating. The additive concentration gradient can be linear, exponential, logarithmic, or piecewise in concentration. In a particular embodiment, the additive concentration gradient can be adapted such that the coating maintains a substantially constant release rate throughout the release of the additive.

As illustrated in FIG. 2, the coating can be a single layer 310 that includes an concentration gradient within the layer. As discussed above, the additive concentration gradient in layer 310 can be linear, exponential, logarithmic, or piecewise in concentration.

As illustrated in FIG. 3, the coating can include a coating 320 having an additive concentration gradient having a plurality of layers each having a different additive concentration. That is, the additive concentration gradient can be formed by adding multiple discrete layers having successively increasing or decreasing concentrations. For example, to have the additive concentration gradient increase as it moves to the surface interfacing the core, the additive concentration gradient can be formed using layers having successively decreasing concentrations.

The core can include a particulate material. In certain embodiments, the particulate material can include a ceramic material. The ceramic material can include at least one oxide. In particular embodiments, the at least one oxide can include at least one of aluminum, silicon, calcium, magnesium, iron, titanium, zirconium, or any combination thereof. In more particular embodiments, the core can include at least 6 wt % alumina, or at least 8 wt % alumina, or at least 10 wt % alumina, based on the total weight of the core. In further embodiments, the core can include 100 wt % alumina, or at most 90 wt % alumina, or at most 80 wt % alumina, based on a total weight of the core. Further, the core can include at least one of aluminum silicate, aluminum oxide, or any combination thereof. Furthermore, the core can include at least one of mullite, corundum, anorthite, cordierite, spinel, bauxite, dolomite, amorphous SiO₂ phase, hematite, pseudobrookite, quartz, or any combination thereof.

Existing technology delivers additives to a subterranean formation using porous proppants infiltrated with an additive and then sealed with a resin coating. It is a particular advantage of certain embodiments described herein that the additive is not incorporated into a porosity of the core. In certain embodiments, the coating is a shell bonded to an exterior surface of the core. In further embodiments, the coating does not extend into a majority of the porosity of the core. In certain embodiments, all of the additive is contained within the polymer or, in other words, the additive can be contained only within the polymer. In an embodiment, the additive is not infused within a porosity of the core or added as a layer between the coating and the core. In a particular embodiment, the proppant is free of a layer comprising the additive between the extended release coating and the ceramic surface of the core. In particular, the core can contain no greater than 1 wt % of the additive, or no greater than 0.5 wt % of the additive, or no greater than 0.1 wt % of the additive, or can contain 0 wt % of the additive, based on a total amount of additive present in the coated proppant. For example, the interior of the core can be completely free of any additive apart form the coating and/or the surface of the core can be completely free of the additive apart from the coating. It is possible that some of the coating could extend into the interior of the core but the additive alone is not infused into the interior of the core.

In certain embodiments, the core can be a solid core, in that the core does not include any porosity or includes only minimal porosity. In particular embodiments, the core can have a pre-coating porosity of no greater than 25 vol %, or no greater than 20 vol %, or no greater than 15 vol %, or no greater than 10 vol %, or no greater than 5 vol %, or no greater than 1 vol %, based on a total volume of the core. In further embodiments, the core can have a porosity of at least 0.01 vol %, or at least 0.001, or even a fully dense core having a porosity of 0 vol %, based on a total volume of the core. Moreover, the core can have a pre-coating porosity in a range of any of the above minimum and maximum values, such as 0 to 25 vol %, or 0 to 20 vol %, or 0 to 15 vol %, or 0 to 10 vol %, or 0 to 5 vol %, or 0 to 1 vol %.

Resin coatings have been added to porous proppants to increase the crush strength of weaker, porous proppant cores. However, as discussed above, the additive does not require porosity in which to infiltrate the additive. Instead, the additive can be added directly to the surface of the core via the coating. Accordingly, the core can have increased strength as compared to porous proppant cores. In certain embodiments of the proppant described herein, the core can have a crush resistance at 7,500 psi of no greater than 10%, or no greater than 8%, or no greater than 6%, as measured according to ISO 13503-2. Moreover, the core can have a crush resistance at 7,500 psi in a range of any of the above minimum and maximum values, such as 0.01% to 10%, or 0.05% to 8%, or 0.1% to 6%, as measured according to ISO 13503-2. In certain embodiments, the core can have a specific gravity of at least 2, or at least 2.3, or at least 2.6. In further embodiments, the core can have a specific gravity of no greater than 3.7, or no greater than 3.2, or no greater than 3.0. Moreover, the core can have a specific gravity in a range of any of the above minimum or maximum values, such as in a range of 2 to 3.7, or 2.3 to 3.2, or 2.6 to 3.

In certain embodiments, the proppant can be made by a process including providing the core described herein and coating the core with the extended release coating described herein. For example, a batch of cores can be mixed with the coating to coat the cores. The coating can have a viscosity in a range of 0.1 to 350,000 cps, or 0.5 to 325,000 cps, or 1 to 300,000 cps. In particular embodiments, the mixing can include acoustic mixing, mechanical mixing, or fluidized mixing. Further, the coated cores can be cured. In certain embodiments, the coated cores can be cured thermally, chemically, electromagnetically, or any combination thereof. In particular embodiments, the coated cores can be thermally cured at a temperature of at least 25° C., or at least 50° C., or at least 100° C., or at least 150° C., or at least 160° C., or even at least 170° C. It is a particular advantage of certain embodiments described herein that the coated proppant can be manufactured in a direct coating process. For example, the process can skip the step of infiltrating a porous ceramic proppant core with the additive before coating with a resin. By contrast, embodiments described herein incorporate the additive directly into the resin and coating the outer surface of the proppant core with the additive-containing polymer.

As discussed earlier in the disclosure, in certain embodiments, the coated proppant can be deposited into a fluid medium. In particular embodiments, the fluid medium can be a predetermined fluid medium appropriate to degrade the polymer and appropriate for the additive to be released into. For example, if an acid chemical is utilized as the additive, it could be released into an aqueous medium, such as a fracking fluid or a brine contained in the fracture. On the other hand, if a surfactant is used, the surfactant may not be soluble in an aqueous medium and, thus, it may be appropriate for the fluid medium to include a hydrocarbon. Further, the fluid medium can be disposed within a subterranean formation, such as a wellbore. It is a particular advantage of certain embodiments described herein that the coating can extend the release of the additive into the fluid medium. The extended release can increase exposure of the subterranean formation to the additive for an extended time frame.

### EXAMPLE

Sample proppants were prepared and tested for their additive delivery properties. For each sample, the core was comprised of anorthite, sapphirine, mullite, and an amorphous silicate. The core was sintered in the range of 1000-1450° C. for 2 hours. The resulting open porosity was approximately 24% with a pore size distribution centered at approximately 0.9 μm.

The samples were batched such that the resin would account for 6 wt % based on the total weight of the coating and the core, and such that the additive would account for an additional 5 wt %, based on the total weight of the coating and the core, for a total of 50 g of core, 3 g of resin, and 5 g of nitrilotri(methylphopshonic) acid as the additive. The nitrilotri(methylphopshonic) acid was as a 50 vol % aqueous solution.

Two resin types were used to demonstrate a comparison in release of the additive. Resin 1 was a phenolic resin under the trade name R225, available from ARCLIN at Roswell, Ga., USA. Resin 2 was a resin including a mixture of a polyol under the trade name ROCLYS C307 2S (available from ROQUETTE), a citric acid, and a sodium hypophosphite in an aqueous solution.

For Sample 1, the additive was incorporated onto the proppant by direct coating of Resin 1 containing the additive onto the proppant core, according to an embodiment described herein. The direct coating method included a direct one step process of coating the proppant core with a resin containing the additive. To prepare the coating, the additive was mixed with the resin. The proppant core was then uniformly coated with the additive-containing resin by mixing. The coating was then cured at 170° C. for 1 hour. This sample proppant material is referred to as Sample 1.

For Sample 2, the additive was incorporated onto the proppant by direct coating of Resin 2 containing the additive onto the proppant core, according to an embodiment described herein. The direct coating method included a direct one step process of coating the proppant core with a resin containing the additive. To prepare the coating, the additive was mixed with the resin. The proppant core was then uniformly coated with the additive-containing resin by mixing. The coating was then cured at 170° C. for 1 hour. This sample proppant material is referred to as Sample 2.

The testing for release rate of the additives was done by submerging 25 g of proppants incorporated with the additive-containing resin into a brine solution. The brine solution was formed according to ASTM D1141-98. It is noted that only the material containing the phosphonic acid was tested using this brine solution.

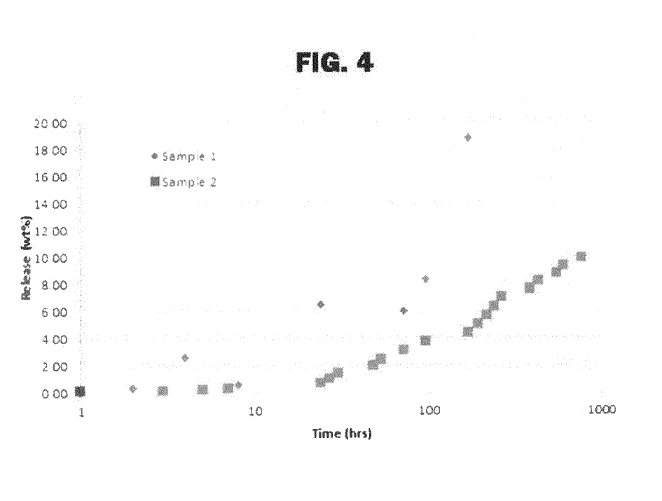

The cumulative release of phosphonic acid from the proppants is shown in FIG. 4. In particular, FIG. 4 includes a graph plotting the release in weight percent of phosphonic acid into a brine solution and providing a comparison of proppants coated with a chemical mixture of two different resins.

Sample 1 degraded faster than Sample 2 in a brine solution. In this case, the acid release was significant after about 168 hours, approximately 20% released. By contrast, for Sample 2, only a total of 10% was released over a 1 month period.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the embodiments as listed below.

### Embodiment 1

A proppant comprising:

a ceramic core;

an extended-release coating overlying the ceramic core;

the extended-release coating comprising a polymer and at least one additive contained within the polymer;

wherein the at least one additive is only contained within the polymer.

### Embodiment 2

A proppant comprising:

a core;

an extended-release coating overlying the core;

the extended release coating comprising a polymer and at least one additive contained within the polymer;

wherein the extended-release coating has a Period 1 release rate in a range of 0.01 wt % to 1 wt %/o, according to Additive Release Test.

### Embodiment 3

A proppant comprising:

a core; and

an extended-release coating overlying the core;

the extended-release coating comprising a polymer and at least one additive contained within the polymer;

the polymer comprising an epoxy polymer, an acrylic polymer, a polyurethane, a formaldehyde, a silicone, a bio-based polymer, or any combination thereof;

the additive comprising an imidazoline, an ethylene vinyl acetate, an olefin, an acrylate, a phosphonic acid, phosphoric acid, a fumaric acid, a polymaleic acid, a polymethacrylic acid, a polyacrylic acid, a polyepoxysuccinic acid, a carboxylates, a graphite, a caprylic alcohol, an acrylamide, an ammonium sulfate, a polytetrafluoroethylene, an inorganic salt, a magnetic particle, a dye, a fluorescent compound, a biological marker, a nonyl-phenol formaldehyde alkylphenol/aldehyde resin, a polyolefin ester, a lignosulfonate, an organic nitrate, an inorganic nitrate, a 2,2-dibromo-3-nitrilopropionamide (DBNPA), an acetaldehyde, an ammonium bisulfite, a benzylideneacetaldehyde, a potassium acetate, a formamide, or any combination thereof.

### Embodiment 4

A proppant comprising:

a core having a ceramic surface; and

an extended-release coating overlying the core;

the extended-release coating comprising a polymer and at least one additive contained within the polymer;

wherein the proppant is free of a layer comprising the at least one additive between the extended release coating and the ceramic surface of the core.

### Embodiment 5

A proppant comprising:

a core; and

an extended-release coating overlying the core;

the extended release coating comprising a polymer, at least one additive contained within the polymer, and at least one control mechanism selected from the group consisting of a porosity of at least 0.1 vol % based on a total volume of the coating, a coating stabilizer, an additive concentration gradient, or any combination thereof.

### Embodiment 6

A method of making the proppant of any one of the preceding embodiments, the method comprising forming the extended-release coating overlying the core.

### Embodiment 7

A method of treating a subterranean formation, the method comprising:

disposing a composition including a proppant into a subterranean formation, wherein the composition comprises:

a fluid medium; and

the proppant of any one of embodiments 1 to 5.

### Embodiment 8

The proppant or method of any one of the preceding embodiments, wherein the proppant has an extended-release coating with a Period 1 release rate of at most 1 wt %, according to Additive Release Test.

### Embodiment 9

The proppant or method of embodiment 8, wherein the test fluid medium is a brine solution made according to ASTMD1141-98.

### Embodiment 10

The proppant or method of embodiment 8, wherein the test fluid medium is a hydrocarbon-based solution.

### Embodiment 11

The proppant or method of any one of the preceding embodiments, wherein the extended-release coating has a porosity of at least 0.1 vol %, or at least 0.5 vol %, or at least 1 vol %, or at least 5 vol %, based on a total volume of the coating.

### Embodiment 12

The proppant or method of any one of the preceding embodiments, wherein the extended-release coating has a porosity of at most 60 vol %, or at most 55 vol %, or at most 50 vol %, based on a total volume of the coating.

### Embodiment 13

The proppant or method of any one of the preceding embodiments, wherein the extended-release coating has a plurality of pores have a average pore size of at least 0.1 microns, or a pore size of at least 0.5 microns, or a pore size of at least 1 micron.

### Embodiment 14

The proppant or method of any one of the preceding embodiments, wherein the extended-release coating has a plurality of pores have a pore size of at most 35 microns, or at most 30 microns, or at most 25 microns.

### Embodiment 15

The proppant or method of any one of the preceding embodiments, wherein the extended-release coating comprises a thermal stabilizer, a UV stabilizer, or a combination thereof.

### Embodiment 16

The proppant or method of any one of the preceding embodiments, wherein the extended-release coating comprises at least one stabilizer selected from the group consisting of a hinder amine stabilizer (HAS), a benzophenone, a berrzotriazole, a benzoate, a salicylate, an acrylonitrile, a dilauryl thiodipropionate, a phenolic antioxidant, a pigment, or any combination thereof.

### Embodiment 17

The proppant or method of any one of the preceding embodiments, wherein the extended-release coating comprises a coating stabilizer in an amount of at least 0.001 wt %, or at least 0.005 wt %, or at least 0.01 wt %, based on a total weight of the coating.

### Embodiment 18

The proppant or method of any one of the preceding embodiments, wherein the extended-release coating comprises a coating stabilizer in an amount of at most 4 wt %, or at most 3 wt %, or at most 2 wt %, based on a total weight of the coating.

### Embodiment 19

The proppant or method of any one of the preceding embodiments, wherein the extended-release coating comprises an additive concentration gradient wherein an additive concentration increases from an exterior surface to a coating interface with the core.

### Embodiment 20

The proppant or method of any one of the preceding embodiments, wherein the core has a specific gravity of at least 2, or at least 2.3, or at least 2.6.

### Embodiment 21

The proppant or method of any one of the preceding embodiments, wherein the core has a specific gravity of no greater than 3.7, or no greater than 3.2, or no greater than 3.0.

### Embodiment 22

The proppant or method of any one of the preceding embodiments, wherein the core has a specific gravity in a range of 2 to 3.7, or 2.3 to 3.2, or 2.6 to 3.

### Embodiment 23

The proppant or method of any one of the preceding embodiments, wherein the core has a porosity of no greater than 25 vol %, or no greater than 20 vol %, or no greater than 15 vol %, or no greater than 10 vol %, or no greater than 5 vol %, or no greater than 1 vol %, based on a total volume of the core.

### Embodiment 24

The proppant or method of any one of the preceding embodiments, wherein the core has a porosity of 0 vol %, at least 0.001 vol %, or at least 0.01 vol %, based on a total volume of the core.

### Embodiment 25

The proppant or method of any one of the preceding embodiments, wherein the core has a porosity in a range of 0 to 25 vol %, or 0 to 20 vol %, or 0 to 15 vol %, or 0 to 10 vol %, or 0 to 5 vol %, or 0 to 1 vol %.

### Embodiment 26

The proppant or method of any one of the preceding embodiments, wherein the core has a crush resistance at 7,500 psi of no greater than 10%, or no greater than 8%, or no greater than 6%, according to ISO 13503-2.

### Embodiment 27

The proppant or method of any one of the preceding embodiments, wherein the core has a crush resistance at 7,500 psi in a range of 0.01% to 10%, or 0.05% to 8%, or 0.1% to 6%, according to ISO 13503-2.

### Embodiment 28

The proppant or method of any one of the preceding embodiments, wherein the core comprises a ceramic material.

### Embodiment 29

The proppant or method of any one of the preceding embodiments, wherein the core comprises a ceramic material comprising an oxide.

### Embodiment 30

The proppant or method of any one of the preceding embodiments, wherein the core comprises a ceramic material comprising at least one of aluminum, silicon, calcium, magnesium, iron, titanium, zirconium, or any combination thereof.

### Embodiment 31

The proppant or method of any one of the preceding embodiments, wherein the core comprises a ceramic material comprising at least 6% alumina, or at least 8% alumina, or at least 10% alumina, based on a total weight of the core.

### Embodiment 32

The proppant or method of any one of the preceding embodiments, wherein the core comprises at least one of aluminum silicate, aluminum oxide, or any combination thereof.

### Embodiment 33

The proppant or method of any one of the preceding embodiments, wherein the core comprises at least one of mullite, corundum, anorthite, cordierite, spinel, bauxite, dolomite, amorphous SiO2 phase, quartz, pseudobrookite, hematite, or any combination thereof.

### Embodiment 34

The proppant or method of any one of the preceding embodiments, wherein the polymer comprises a resin.

### Embodiment 35

The proppant or method of any one of the preceding embodiments, wherein the polymer comprises an epoxy polymer, an acrylic polymer, a polyurethane, a formaldehyde, a silicone, a bio-based polymer, or any combination thereof.

### Embodiment 36

The proppant or method of any one of the preceding embodiments, wherein the polymer comprises an epoxy polymer, the epoxy polymer including a bisphenol epoxy, a novolac epoxy, an aliphatic epoxy, a glycidyl amine epoxy, or any combination thereof.

### Embodiment 37

The proppant or method of any one of the preceding embodiments, wherein the polymer comprises an acrylic polymer, the acrylic polymer including a methacrylate, methyl acrylate, a polymethyl acrylate, or any combination thereof.

### Embodiment 38

The proppant or method of any one of the preceding embodiments, wherein the polymer comprises a polyurethane, the polyurethane polymer including a combination of an isocyanate and a polyol.

### Embodiment 39

The proppant or method of embodiment 38, wherein the isocyanate includes a toluene diisocyanate or a methylene diphenyl diisocyante.

### Embodiment 40

The proppant or method of any one of embodiments 38 and 39, wherein the polyol includes a sucrose or a sorbitol.

### Embodiment 41

The proppant or method of any one of the preceding embodiments, wherein the polymer comprises a formaldehyde, the formaldehyde including a phenol formaldehyde, a melamine formaldehyde, a urea formaldehyde, a resorcinol formaldehyde, or any combination thereof.

### Embodiment 42

The proppant or method of any one of the preceding embodiments, wherein the polymer comprises a silicone, the silicone comprising a siloxane.

### Embodiment 43

The proppant or method of any one of the preceding embodiments, wherein the polymer comprises a bio-based polymer, the bio-based polymer including a sugar, a starch, or any combination thereof.

### Embodiment 44

The proppant or method of any one of the preceding embodiments, wherein the polymer comprises a bio-based polymer, the bio-based polymer including a sugar comprising a saccharose, a dextrose, a molasses, or any combination thereof.

### Embodiment 45

The proppant or method of any one of the preceding embodiments, wherein the polymer is present in the coating in an amount of at least 10 wt %, or at least 20 wt/o, or at least 40 wt %, or at least 60 wt %, or at least 80 wt %, based on a total weight of the coating.

### Embodiment 46

The proppant or method of any one of the preceding embodiments, wherein the polymer is present in an amount of no greater than 99.99 wt %, no greater than 99.95 wt %, or no greater than 99.9 wt %, based on a total weight of the coating.

### Embodiment 47

The proppant or method of any one of the preceding embodiments, wherein the polymer is present in a range of 10 wt % to 99.9 wt %, 20 wt % to 99.9 wt %, or 40 wt % to 99.9 wt %, or 60 wt % to 99.95 wt %, or 80 wt % to 99.99 wt %, based on a total weight of the coating.

### Embodiment 48

The proppant or method of any one of the preceding embodiments, wherein the additive is adapted for stimulation, treatment, or tracking of a subterranean formation.

### Embodiment 49

The proppant or method of any one of the preceding embodiments, wherein the additive includes a paraffin inhibitor, a scale inhibitor, a friction reducer, a tracer, an asphaltene inhibitor, a biocide, an oxygen inhibitor, an iron sulfide inhibitor, an iron inhibitor, a hydrogen sulfide inhibitor, or any combination thereof.

### Embodiment 50

The proppant or method of any one of the preceding embodiments, wherein the additive includes an imidazoline, an ethylene vinyl acetate, an olefin, an acrylate, a phosphonic acid, phosphoric acid, a fumaric acid, a polymaleic acid, a polymethacrylic acid, a polyacrylic acid, a polyepoxysuccinic acid, a carboxylate, a graphite, a caprylic alcohol, an acrylamide, an ammonium sulfate, a polytetrafluoroethylene, an inorganic salt, a magnetic particle, a dye, a fluorescent compound, a biological marker, a nonyl-phenol formaldehyde alkylphenol/aldehyde resin, a polyolefin ester, a lignosulfonate, an organic nitrate, an inorganic nitrate, a 2,2-dibromo-3-nitrilopropionamide, an acetaldehyde, an ammonium bisulfite, a benzylideneacetaldehyde, a potassium acetate, a formamide, or any combination thereof.

### Embodiment 51

The proppant or method of any one of the preceding embodiments, wherein the additive is contained within the polymer in an amount of no greater than 90 wt %, or no greater than 80 wt %, no greater than 60 wt %, no greater than 40 wt %, or no greater than 20 wt %, based on a total weight of the coating.

### Embodiment 52

The proppant or method of any one of the preceding embodiments, wherein the additive is contained within the polymer in an amount of at least 0.01 wt %, or at least 0.05 wt %, or at least 0.1 wt %, based on a total weight of the coating.

### Embodiment 53

The proppant or method of any one of the preceding embodiments, wherein the additive is contained within the polymer in an amount in a range of 90 wt % to 0.1 wt %, or 80 wt % to 0.1 wt %, or 60 wt % to 0.1 wt %, or 40 wt % to 0.05 wt %, or 40 wt % to 0.05 wt %, or 20 wt % to 0.01 wt %, based on a total weight of the coating.

### Embodiment 54

The proppant or method of any one of the preceding embodiments, wherein the additive is present in the coated proppant in an amount of no greater than 50 wt %, or no greater than 45 wt %, or no greater than 40 wt %, based on the total weight of the coated proppant.

### Embodiment 55

The proppant or method of any one of the preceding embodiments, wherein the additive is present in the coated proppant in an amount of at least 0.01 wt %, or at least 0.05 wt %, or at least 0.1 wt %, based on the total weight of the coated proppant.

### Embodiment 56

The proppant or method of any one of the preceding embodiments, wherein the additive is present in the coated proppant in a range of 0.01 wt % to 50 wt %, or 0.05 wt % to 45 wt %, or 0.1 wt % to 40 wt %, based on the total weight of the coated proppant

### Embodiment 57

The proppant or method of any one of embodiments 2 to 56, wherein the core contains no greater than 1 wt % of the additive, or no greater than 0.5 wt % of the additive, or no greater than 0.1 wt % of the additive, or contains 0 wt % of the additive, based on a total amount of additive present in the coated proppant.

### Embodiment 58

The proppant or method of any one of embodiments 2 to 57, wherein the additive is contained solely within the polymer.

### Embodiment 59

The proppant or method of any one of the preceding embodiments, wherein the coating is a shell bonded to an exterior surface of the core.

### Embodiment 60

The proppant or method of any one of the preceding embodiments, wherein the extended-release coating has a 1 hour release rate of at most 1 wt %, or at most 0.9 wt %, or at most 0.8 wt %, or at most 0.7 wt %, according to Additive Release Test.

### Embodiment 61

The proppant or method of any one of the preceding embodiments, wherein the extended-release coating has a 1 hour release rate of at least 0.01 wt %, or at least 0.02 wt %, or at least 0.03 wt %, according to Additive Release Test.

### Embodiment 62

The proppant or method of any one of the preceding embodiments, wherein the extended-release coating has a 24 hour release rate of at most 6 wt %, or at most 8 wto, according to Additive Release Test.

### Embodiment 63

The proppant or method of any one of the preceding embodiments, wherein the extended-release coating has a 24 hour release rate of at least 0.01 wt %, or at least 0.02 wt %, or at least 0.03 wt %, according to Additive Release Test.

### Embodiment 64

The proppant or method of any one of the preceding embodiments, wherein the extended-release coating has a 168 hour release rate of at most 16 wt %, or at most 18 wt %, or at most 20 wt %, according to Additive Release Test.

### Embodiment 65

The proppant or method of any one of the preceding embodiments, wherein the extended-release coating has a 168 hour release rate of at least 0.01 wt %, or at least 0.02 wt %, or at least 0.03 wt %, according to Additive Release Test.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A proppant comprising:
a ceramic core;
an extended-release coating overlying the ceramic core;
the extended-release coating comprising a polymer and at least one additive contained within the polymer,
wherein the at least one additive is only contained within the polymer.

2. The proppant of claim 1 wherein the extended-release coating has a Period 1 release rate in a range of 0.01 wt % to 1 wt %, according to Additive Release Test.

3. The proppant of claim 1 wherein said polymer comprises an epoxy polymer, an acrylic polymer, a polyurethane, a formaldehyde, a silicone, a bio-based polymer, or any combination thereof; and
said additive comprises an imidazoline, an ethylene vinyl acetate, an olefin, an acrylate, a phosphonic acid, phosphoric acid, a fumaric acid, a polymaleic acid, a polymethacrylic acid, a polyacrylic acid, a polyepoxysuccinic acid, a carboxylates, a graphite, a caprylic alcohol, an acrylamide, an ammonium sulfate, a polytetrafluoroethylene, an inorganic salt, a magnetic particle, a dye, a fluorescent compound, a biological marker, a nonyl-phenol formaldehyde alkylphenol/aldehyde resin, a polyolefin ester, a lignosulfonate, an organic nitrate, an inorganic nitrate, a 2,2-dibromo-3-nitrilopropionamide (DBNPA), an acetaldehyde, an ammonium bisulfite, a benzylideneacetaldehyde, a potassium acetate, a formamide, or any combination thereof.

4. The proppant of claim 1 wherein said proppant is free of a layer comprising the at least one additive between the extended release coating and the ceramic surface of the core.

5. The proppant of claim 1 wherein said extended release coating comprising a polymer, at least one additive contained within the polymer, and at least one control mechanism selected from the group consisting of a porosity of at least 0.1 vol % based on a total volume of the coating, a coating stabilizer, an additive concentration gradient, or any combination thereof.

6. The proppant of claim 1 wherein the extended-release coating has a porosity of at least 0.1 vol % based on a total volume of the coating.

7. The proppant of claim 1 wherein the extended-release coating has a porosity of at most 60 vol % based on a total volume of the coating.

8. The proppant of claim 1 wherein the extended-release coating has a plurality of pores and said pores have an average pore size of at least 0.1 microns.

9. The proppant of claim 1 wherein the extended-release coating has a plurality of pores and said pores have a pore size of at most 35 microns.

10. The proppant of claim 1 wherein the extended-release coating comprises a thermal stabilizer, a UV stabilizer, or a combination thereof.

11. The proppant of claim 1 wherein the extended-release coating comprises an additive concentration gradient wherein an additive concentration increases from an exterior surface to a coating interface with the core.

12. The proppant of claim 1 wherein the core has a porosity of no greater than 25 vol % based on a total volume of the core.

13. The proppant of claim 1 wherein the core has a crush resistance at 7,500 psi of no greater than 10% according to ISO 13503-2.

14. The proppant of claim 1 wherein the core comprises a ceramic material selected from the group consisting of aluminum, silicon, calcium, magnesium, iron, titanium and zirconium.

15. The proppant of claim 1 wherein the polymer comprises a resin.

16. The proppant of claim 1 wherein the polymer is present in the coating in an amount of at least 10 wt % based on a total weight of the coating.

17. The proppant of claim 1 wherein the additive is contained within the polymer in an amount of no greater than 90 wt % based on a total weight of the coating.

18. The proppant of claim 1 wherein the additive is present in the coated proppant in an amount of no greater than 50 wt % based on the total weight of the coated proppant.

19. The proppant of claim 1 wherein the core contains no greater than 1 wt % of the additive based on a total amount of additive present in the coated proppant.

20. The proppant of claim 1 wherein the additive is contained solely within the polymer.
